(19) United States
(12) Patent Application Publication
(10) Pub. No.: US 2026/0070334 A1
(43) Pub. Date: Mar. 12, 2026

(54) LIQUID DISCHARGE HEAD AND LIQUID DISCHARGE APPARATUS

(71) Applicant: Takashi KINOKUNI, Tokyo (JP)

(72) Inventor: Takashi KINOKUNI, Tokyo (JP)

(21) Appl. No.: 19/309,710

(22) Filed: Aug. 26, 2025

(30) Foreign Application Priority Data
Sep. 12, 2024 (JP) 2024-158441

(51) Int. Cl. B41J 2/14

(52) U.S. Cl. CPC B41J 2/14201; B41J 2/1433; B41J 2002/14338; B41J 2002/14419; B41J 2002/14491

(57) ABSTRACT

A liquid discharge head includes: a nozzle plate having multiple nozzles to discharge a liquid, the multiple nozzles arrayed in a first direction and a second direction intersecting the first direction; a pressure chamber substrate on the nozzle plate, the pressure chamber substrate having multiple pressure chambers respectively communicating with the multiple nozzles; multiple actuators, respectively disposed at the multiple nozzles, in the nozzle plate, the multiple actuators to respectively discharge the liquid in the multiple pressure chambers from the multiple nozzles; and a common chamber substrate on the pressure chamber substrate, the common chamber substrate having a common chamber communicating with each of the multiple pressure chambers; a heat generator at one side of the common chamber in the first direction; and a first region in a vicinity of the heat generator in the common chamber in the first direction.

### CROSS-REFERENCE TO RELATED APPLICATIONS

This patent application is based on and claims priority pursuant to 35 U.S.C. § 119(a) to Japanese Patent Application No. 2024-158441, filed on Sep. 12, 2024, in the Japan Patent Office, the entire disclosure of which is hereby incorporated by reference herein.

### BACKGROUND

### Technical Field

The present disclosure relates to a liquid discharge head and a liquid discharge apparatus.

### Related Art

A liquid discharge head includes: a nozzle plate having multiple nozzles that discharge liquid; a pressure chamber substrate having multiple pressure chambers each communicating with corresponding one of the multiple nozzles; multiple actuators each provided for corresponding one of the multiple pressure chambers; and a common chamber substrate having a common chamber communicating with each of the multiple pressure chambers. The liquid discharge head drives the actuators to discharge the liquid in the pressure chambers from the nozzles.

There is a liquid discharge head including a drive circuit that drives an actuator. The drive circuit is provided at one end of the pressure chamber substrate, the one end being located on a side where the nozzle plate is located.

### SUMMARY

The present disclosure provides a liquid discharge head including: a nozzle plate having multiple nozzles to discharge a liquid, the multiple nozzles arrayed in a first direction and a second direction intersecting the first direction; a pressure chamber substrate on the nozzle plate, the pressure chamber substrate having multiple pressure chambers respectively communicating with the multiple nozzles; multiple actuators, respectively disposed at the multiple nozzles, in the nozzle plate, the multiple actuators to respectively discharge the liquid in the multiple pressure chambers from the multiple nozzles; and a common chamber substrate on the pressure chamber substrate, the common chamber substrate having a common chamber communicating with each of the multiple pressure chambers; a heat generator at one side of the common chamber in the first direction; a first region in a vicinity of the heat generator in the common chamber in the first direction; a second region at a center of the common chamber in the first direction; and an extension portion extending from the first region to the second region in the first direction in the common chamber.

The present disclosure further provides a liquid discharge head including: a nozzle plate having multiple nozzles to discharge a liquid, the multiple nozzles arrayed in a first direction and a second direction intersecting the first direction; a pressure chamber substrate on the nozzle plate, the pressure chamber substrate having multiple pressure chambers respectively communicating with the multiple nozzles; multiple actuators, respectively disposed at the multiple nozzles, in the nozzle plate, the multiple actuators to respectively discharge the liquid in the multiple pressure chambers from the multiple nozzles; and a common chamber substrate on the pressure chamber substrate, the common chamber substrate having a common chamber communicating with each of the multiple pressure chambers; and multiple heat generators at both sides, in the first direction, of: the pressure chamber substrate; or the nozzle plate, the multiple heat generators arrayed in the second direction; and an extension portion to transfer a first amount of heat generated from the multiple heat generators in the common chamber in the first direction. The extension portion transfers a second amount of heat smaller than the first amount in the common chamber in the second direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic cross-sectional view of a liquid discharge head;

FIG. 2 is an enlarged cross-sectional view of one pressure chamber of the liquid discharge head, which illustrates a peripheral configuration of the one pressure chamber;

FIG. 3 is an explanatory diagram illustrating wiring portions connecting drive circuits and piezoelectric elements of the liquid discharge head;

FIG. 4 is an enlarged explanatory diagram illustrating the wiring portions connecting the drive circuits and the piezoelectric elements of the liquid discharge head;

FIGS. 5A to 5C are schematic exploded views of the liquid discharge head;

FIG. 6 is a schematic cross-sectional view of a liquid discharge head according to a first modification;

FIGS. 7A to 7C are schematic exploded views of the liquid discharge head according to the first modification;

FIG. 8 is a schematic cross-sectional view of a liquid discharge head according to a second modification;

FIGS. 9A to 9C are schematic exploded views of the liquid discharge head according to the second modification;

FIG. 10 is a schematic cross-sectional view of a liquid discharge head according to a third modification;

FIGS. 11A to 11C are schematic exploded views of the liquid discharge head according to the third modification;

FIG. 12 is a schematic explanatory diagram illustrating a printing apparatus;

FIG. 13 is an explanatory diagram illustrating a plan view of an example of a head device of the printing apparatus;

FIG. 14 is an explanatory diagram illustrating a plan view of a main part of another printing apparatus;

FIG. 15 is an explanatory diagram illustrating a side view of the main part of another printing apparatus;

FIG. 16 is an explanatory diagram illustrating a plan view of a main part of a liquid discharge device of another example; and

FIG. 17 is an explanatory diagram illustrating a front view of a liquid discharge device of still another example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected, and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context indicates otherwise.

A description is given below of an embodiment of the present disclosure to be applied to a liquid discharge head installed in a liquid discharge apparatus.

Note that the following embodiment and modifications are not limiting the present disclosure and any deletion, addition, modification, change, etc. can be made within a scope in which a person skilled in the art can conceive including other embodiments, and any of which is included within the scope of the present disclosure as long as the effect and feature of the present disclosure are demonstrated.

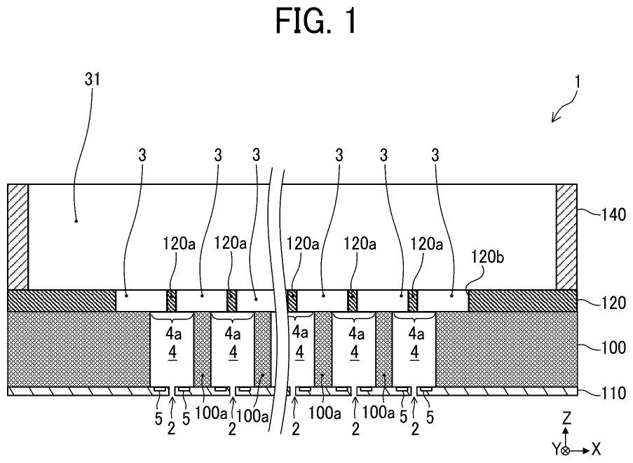

FIG. 1 is a schematic cross-sectional view of a nozzle plate vibration-type liquid discharge head. In the following description, the X direction is defined as the longitudinal direction of a liquid discharge head 1, the Y direction is defined as the lateral direction of the liquid discharge head 1, and the Z direction is defined as the height direction. The Y direction is also referred to as a “first direction”, the X direction is also referred to as a “second direction”, and the Z direction is also referred to as a “discharge direction”.

The liquid discharge head 1 is a nozzle plate vibration type liquid discharge head that discharges liquid in a pressure chamber 4 from a nozzle 2 by changing pressure in the pressure chamber 4 using a piezoelectric element 5 serving as an actuator provided on a nozzle plate 110 (nozzle forming wall) having the nozzle 2. The nozzle plate vibration type liquid discharge head is characterized in that droplets can be splashed with a smaller force than a general unimorph piezo head (that discharges liquid by vibrating a surface of a pressure chamber facing a wall portion (nozzle forming wall) communicating with a nozzle of the pressure chamber). Thus, the nozzle plate vibration type liquid discharge head can achieve power saving of the actuators.

The liquid discharge head 1 includes the nozzle plate 110, a pressure chamber substrate 100, a common chamber substrate 120, and a frame 140. The nozzle plate 110 is formed like a thin film, and includes multiple nozzles 2 and the piezoelectric elements 5. The multiple nozzles 2 discharge liquid. The piezoelectric elements 5 each serve as an electromechanical transducer element, which is an annular actuator disposed around the nozzle 2. Multiple pressure chambers 4, communicating with the multiple nozzles 2, are formed in the pressure chamber substrate 100. The nozzle 2 (vibrating membrane 103) is formed on one surface of each pressure chamber 4, and an opening 4a of the pressure chamber 4 is disposed on a side facing the one surface. The common chamber substrate 120 includes a common chamber 3 communicating with the multiple pressure chambers 4.

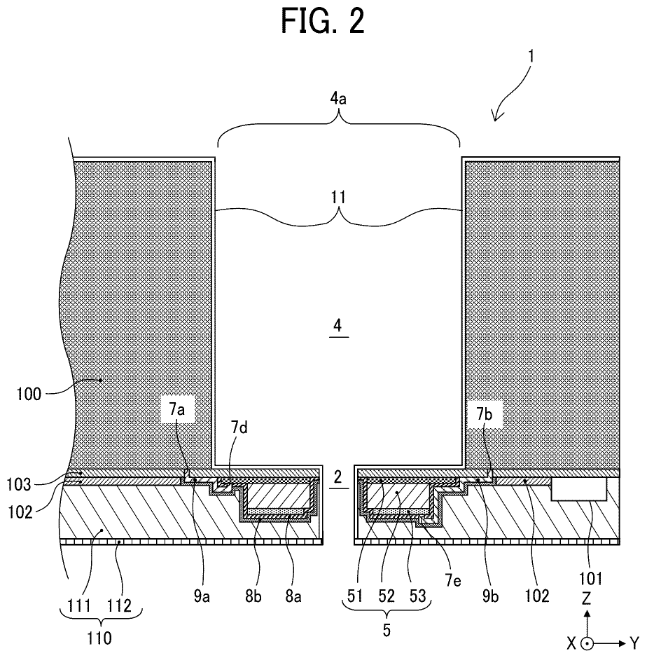

FIG. 2 is an enlarged cross-sectional view of one pressure chamber 4, which illustrates a peripheral configuration of the one pressure chamber 4.

The pressure chamber substrate 100 is a silicon-on-insulator (SOI) substrate. A drive circuit 101, which serves as a heat generator, and a wiring portion 102 are disposed after the formation of the vibrating membrane 103. The drive circuit 101 and the wiring portion 102 are formed on the nozzle plate 110. The vibrating membrane 103 may be formed after the drive circuit 101 and the wiring portion 102 are disposed, and the drive circuit 101 may be formed on the pressure chamber substrate 100. The drive circuit 101 is a complementary metal-oxide semiconductor (CMOS) circuit including a transistor, a resistor, and the like. The wiring portion 102 includes a wire for applying a drive waveform (drive signal) from the drive circuit 101 to a second electrode 53 (also referred to as an upper electrode).

The nozzle plate 110 includes a nozzle forming portion 111 (nozzle forming membrane) that covers the piezoelectric elements 5. The multiple nozzles 2 are formed in the nozzle forming portion 111. A liquid-repellent membrane 112 is formed on the nozzle surface of the nozzle forming portion 111. In a case where liquid is continuously discharged, mist generated simultaneously with the liquid discharge adheres to the nozzle surface. When a large amount of mist adheres to the nozzle surface, there is a possibility that the liquid discharged from the nozzle 2 is affected by the liquid having adhered to the nozzle surface, and deviates from the desired position where the liquid is to be applied. Formation of the liquid-repellent membrane 112 on the nozzle surface can prevent adhesion of liquid to the nozzle surface. Thus, liquid discharged from the nozzle 2 can be prevented from being affected by liquid that has adhered to the nozzle surface.

The piezoelectric element 5 of the nozzle plate 110 includes a first electrode 51 (also referred to as a lower electrode), a piezoelectric membrane 52, and the second electrode 53 (also referred to as an upper electrode). The piezoelectric element 5 is covered with a first insulating film 8a. The first insulating film 8a has a third contact 7d and a fourth contact 7e. The third contact 7d is a hole-shaped contact for making an electrical connection to the first electrode 51. The fourth contact 7e is a hole-shaped contact for making an electrical connection to the second electrode 53.

A first lead wire 9a is formed on the first insulating film 8a. The first lead wire 9a electrically connects the first electrode 51 of the piezoelectric element 5 and the wiring portion 102 of the pressure chamber substrate 100. Furthermore, a second lead wire 9b is also formed on the first insulating film 8a. The second lead wire 9b electrically connects the second electrode 53 of the piezoelectric element 5 and the wiring portion 102 of the pressure chamber substrate 100.

The first lead wire 9a is electrically connected to the first electrode 51 via the third contact 7d, and is electrically connected to the wiring portion 102 via a first contact 7a. The second lead wire 9b is electrically connected to the second electrode 53 via the fourth contact 7e, and is electrically connected to the wiring portion 102 via a second contact 7b. The first lead wire 9a and the second lead wire 9b are covered with a second insulating film 8b. The second insulating film 8b also covers the piezoelectric element 5. The second insulating film 8b has a function of preventing moisture that has entered the nozzle forming portion 111 made of resin, from entering the piezoelectric element 5, to protect the piezoelectric element 5.

Each of the first electrode 51 and the second electrode 53 may be provided with a lead wire so as to be directly electrically connected to the wiring portion 102 via a contact opened in the vibrating membrane. An adhesion-improving membrane for ensuring adhesion to the nozzle forming portion 111 may be formed on the second insulating film 8b.

Liquid, having filled the liquid discharge head 1, enters the nozzle 2 and forms a meniscus in the nozzle. A predetermined drive waveform from the drive circuit 101 is applied to each of the first electrode 51 and the second electrode 53 of the piezoelectric element 5. As a result, the piezoelectric membrane 52 is displaced (vibrated), and the vibrating membrane 103 vibrates in a vertical direction in FIG. 2 such that a wall portion of the pressure chamber substrate 100, which divides the pressure chambers 4 from each other, serves as a fixed end. As a result of the vibration of the vibrating membrane 103, a change in pressure occurs in liquid in the pressure chamber to cause the liquid to be discharged from the nozzle 2.

The liquid discharge head 1 includes a protective membrane 11 formed on an inner peripheral surface of the nozzle 2, an inner peripheral surface of the pressure chamber 4, and a bottom surface of the common chamber 3. The protective membrane 11 serves as a surface layer that is lyophilic to liquid discharged by the liquid discharge head 1 and prevents erosion by the liquid. The liquid to be discharged by the liquid discharge head 1 is alkaline. The pressure chamber substrate 100 and the vibrating membrane 103 forming the pressure chamber 4 are made of silicon single crystal and silicon oxide. These materials are vulnerable to alkaline liquids, and are dissolved in and eroded by alkaline solutions. In order to prevent this, it is possible to protect the pressure chamber substrate 100 and the vibrating membrane 103 from the liquid by forming the liquid-resistant protective membrane 11 that prevents erosion by the liquid.

The pressure chamber 4 and the nozzle 2 are formed by dry etching. When a dry etching gas contains fluorine, a surface membrane containing fluorine is formed on an inner wall surface of the pressure chamber 4 and the inner peripheral surface of the nozzle 2 after etching, and the inner wall surface of the pressure chamber 4 and the nozzle inner peripheral surface become liquid-repellent. When the inner peripheral surface of the pressure chamber 4 is liquid-repellent, liquid does not wet and spread on the inner peripheral surface of the pressure chamber 4 during liquid filling. Therefore, there may be cases where the pressure chamber 4 is not satisfactorily filled with the liquid and thus, air bubbles are generated at corner portions or the like of the pressure chamber 4.

Since the protective membrane 11, which is lyophilic, is formed on the inner peripheral surface of the pressure chamber 4 and the inner peripheral surface of the nozzle 2, it is possible to improve wettability of liquid on the inner peripheral surfaces of the pressure chamber 4 and the nozzle 2. The protective membrane 11 just needs to be more lyophilic to liquid than a film formation surface of the pressure chamber 4 or the nozzle 2 (a lower layer surface of the protective membrane 11) on which the protective membrane 11 is formed. In a case where a solvent for the liquid is aqueous, a highly hydrophilic protective membrane is used. In a case where a solvent for the liquid is oily, a highly lipophilic protective membrane is used. As a result, it is possible to form the protective membrane 11 as a highly lyophilic protective membrane.

As a result of the protective membrane 11, which is lyophilic to liquid with which the pressure chamber 4 is filled, being thus formed on the inner peripheral surfaces of the nozzle 2 and the pressure chamber 4, the liquid easily wets and spreads on the inner peripheral surfaces of the pressure chamber 4 and the nozzle 2 during liquid filling. As a result, filling properties of the liquid can be improved. Thus, it is possible to favorably fill the pressure chamber 4 and the nozzle 2 with the liquid without performing pressurization or suction during liquid filling. Therefore, it is possible to prevent cracks from being produced in the vibrating membrane 103 during liquid filling.

The solvent for the liquid is aqueous. Therefore, as compared with a surface membrane containing fluorine formed by dry etching, it is possible to improve lyophilicity at least by forming the protective membrane 11 not containing fluorine on the inner peripheral surfaces of the pressure chamber 4 and the nozzle 2. In addition to the above, since this membrane is in direct contact with various liquids, it is desirable to use a material having resistance to liquid, such as a metal oxide forming a passive state. Furthermore, as a method for improving the lyophilicity, it is also possible to use a mixture of the metal oxide forming a passive state with silicon dioxide (SiO₂) at the molecular level. As a result of substitution of H for O on the surface, SiO₂ in the protective membrane 11 has an OH group that is hydrophilic. Thus, hydrophilicity can be further imparted to the protective membrane 11. Examples of the metal of the metal oxide include tantalum (Ta), niobium (Nb), titanium (Ti), zirconium (Zr), hafnium (Hf), and tungsten (W) having high correspondence to the number of oxides. In particular, Zr or Hf having a valence similar to the valence of SiO₂, or Ta having a valence before or after the valence of SiO₂ is particularly desirable.

In addition, for example, the protective membrane 11 may have a two-layer structure of a liquid-resistant membrane and a lyophilic membrane. In this case, the liquid-resistant membrane is formed on the inner peripheral surfaces of the nozzle 2 and the pressure chamber 4, and then the lyophilic membrane is formed on the liquid-resistant membrane.

The lyophilic protective membrane 11 is also formed on a surface of the pressure chamber substrate 100 forming the bottom surface of the common chamber 3, the surface being opposite to the film formation surface of the vibrating membrane 103, but the protective membrane 11 on this surface may have merely resistance to liquid. However, it is necessary to provide a step of forming the protective membrane 11 on the bottom surface of the common chamber 3 separately from a step of forming a lyophilic protective membrane on the nozzle inner peripheral surface and the wall surface of the pressure chamber. Thus, the number of manufacturing steps may increase. In addition, formation of the protective membrane 11 on the bottom surface of the common chamber 3 allows the liquid to easily wet and spread on the bottom surface of the common chamber 3. Thus, the filling properties of the liquid are also improved. Therefore, it is preferable to form the lyophilic protective membrane 11 also on the surface of the pressure chamber substrate 100 forming the bottom surface of the common chamber 3, the surface being opposite to the film formation surface of the vibrating membrane 103.

The vibrating membrane 103 just needs to be made of at least an insulating material such as SiO₂, SiN, a metal oxide, or a resin. However, in order to increase a displacement, a material having a low Young's modulus is desirable, and considering a difference in linear expansion coefficient from the pressure chamber substrate 100, silicon dioxide (SiO₂) having a relatively small difference is most desirable as the material of the vibrating membrane 103.

For example, a platinum film can be suitably used for the first electrode 51 and the second electrode 53. A piezoelectric material (material containing AlN, ScAlN, or the like as a main component) prepared through a treatment step in which a heat treatment is performed at a temperature below 450° C. is used as a piezoelectric material to be included in the piezoelectric membrane 52.

The aluminum nitride piezoelectric material is a compound of a trivalent aluminum cation element and a trivalent nitrogen anion element, and has a hexagonal crystal structure. Examples of substitution type material include materials obtained by substitution of boron, scandium, yttrium, lanthanum, and lanthanoid elements for trivalent aluminum. Material of scandium substitution is represented by, for example, Al₍₁₋ₓ₎ or ScₓN, and material of Yb substitution as a lanthanoid element is represented by, for example, Al₍₁₋ₓ₎ or YbₓN.

As a derivative material of aluminum nitride, there is a material design in which a divalent element and a tetravalent element are combined to achieve the same role as the role of a trivalent element, and piezoelectricity superior to the piezoelectricity of aluminum nitride is reported. Specific examples of such material include Mg0.5, Zr0.5N, Zn0.5, and Hf0.5N. Materials such as hexagonal zinc oxide and magnesium zinc oxide can also be cited as examples of such material.

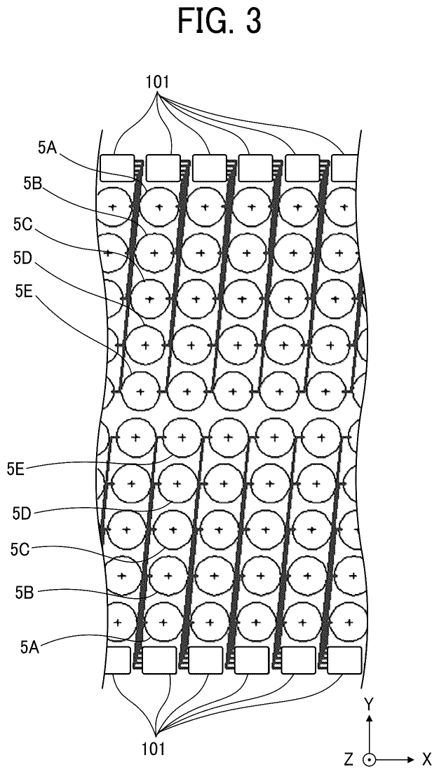

FIG. 3 is an explanatory diagram illustrating the wiring portions 102 connecting the drive circuits 101 and the piezoelectric elements 5 of the liquid discharge head 1.

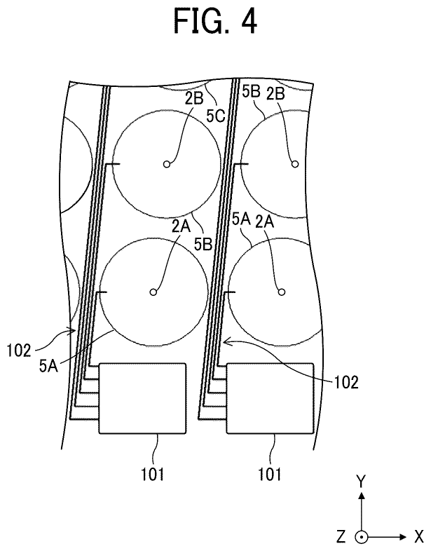

FIG. 4 is an enlarged explanatory diagram illustrating the wiring portions 102 connecting the drive circuits 101 and the piezoelectric elements 5 of the liquid discharge head 1.

In the example of FIG. 3, a single drive circuit 101 is connected to each of the second electrodes 53 (upper electrodes) of five piezoelectric elements 5A to 5E. Specifically, upper five of ten nozzle arrays 5A to 5E extending in a vertical direction in FIG. 3 are connected to the drive circuits 101 on the upper side in FIG. 3, and lower five of the ten nozzle arrays 5A to 5E are connected to the drive circuits 101 on the lower side in FIG. 3.

Note that a nozzle pitch in the horizontal direction in the drawing (nozzle pitch in the same nozzle array) is set to 212 [μm], and a nozzle pitch in a vertical direction in the drawing (nozzle pitch between nozzle arrays adjacent to each other) is set to 191 [μm]. As a result, the liquid discharge head includes multiple nozzle arrays arranged such that nozzle positions in the horizontal direction in the drawing are shifted by 21.2 [μm] between nozzle arrays adjacent to each other. Thus, a high nozzle density of 1200 [npi] is achieved.

As illustrated in FIG. 2, the drive circuits 101 are formed on the nozzle plate 110 on which the piezoelectric elements 5 (5A to 5E) are formed. As a result, the wiring portions 102 between the drive circuits 101 and the piezoelectric elements 5A to 5E can also be formed on the nozzle plate 110. This is advantageous in that the length of wire can be shortened as compared with the case where the drive circuit 101 is formed on the pressure chamber substrate 100 (formed between the pressure chamber substrate 100 and the vibrating membrane 103).

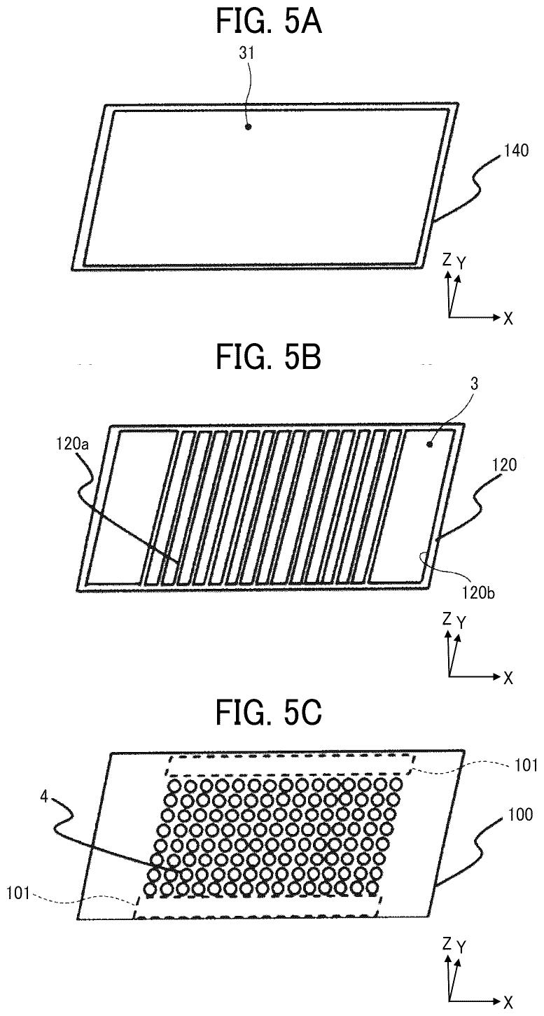

FIGS. 5A to 5C are schematic exploded views of the liquid discharge head 1. FIG. 5A illustrates the frame 140. FIG. 5B illustrates the common chamber substrate 120. FIG. 5C illustrates a drive substrate including the pressure chamber substrate 100 integrated with the nozzle plate 110.

As illustrated in FIG. 5C, multiple pressure chambers 4 are formed in the pressure chamber substrate 100 such that the multiple pressure chambers 4 are arrayed in a two-dimensional direction in correspondence with the multiple nozzles 2 formed in the nozzle plate 110.

An example has been described in which the pressure chamber 4 has a circular cross section in a direction parallel to a substrate surface direction. Meanwhile, the cross-sectional shape of the pressure chamber 4 may be another shape such as an elliptical columnar shape or a polygonal columnar shape. Furthermore, the cross-sectional shape does not need to be uniform in a substrate thickness direction.

The opening 4a of each pressure chamber 4 is opened on an upper surface (a surface facing the common chamber 3) of the pressure chamber substrate 100. The common chamber 3 formed in the common chamber substrate 120 is disposed in such a way as to face the opening 4a of each pressure chamber 4. A fluid resistance portion may be provided between the common chamber 3 and each pressure chamber 4 so as to prevent crosstalk or the like between the pressure chambers.

The common chamber substrate 120 includes multiple extension portions 120a extending from one end in the Y direction (lateral direction of the liquid discharge head) at which one of the drive circuits 101 is disposed to the other end in the Y direction (lateral direction of the liquid discharge head) at which the other drive circuit 101 is disposed. As illustrated in FIG. 1, each extension portion 120a spans the opening 4a of each pressure chamber 4 in the Y direction, but the way of providing the extension portions 120a is not limited thereto. The extension portion 120a is across the opening 4a of each pressure chamber 4 in the Y direction.

The frame 140 illustrated in FIG. 5A is provided on the upper surface of the common chamber substrate 120 (a surface opposite to the pressure chamber substrate 100). Liquid stored in an external liquid storage is supplied to the liquid discharge head 1 through a liquid supply port 33 of the frame 140. The liquid supplied from the liquid supply port is supplied to the common chamber 3 of the common chamber substrate 120 from a supply liquid storage chamber 31 in the frame 140. Thereafter, the liquid in the common chamber 3 is supplied to each pressure chamber 4 of the pressure chamber substrate 100.

In general, the viscosity of liquid to be used in the liquid discharge head 1 often changes depending on the temperature. When the viscosity of the liquid changes, the amount of liquid to be discharged from the nozzle 2 varies. Thus, it becomes difficult to discharge a desired amount of liquid. As a result, when there is a difference in liquid temperature between the nozzles 2 of the liquid discharge head 1 (when there is a difference between liquid temperatures in the pressure chambers corresponding to the nozzles 2), a liquid discharge amount varies between the nozzles 2.

When a piezoelectric element having a high piezoelectric constant such as a piezoelectric zirconate titanate (PZT) is adopted as the piezoelectric element 5, the piezoelectric element generates a relatively large amount of heat as compared with other heat generators that may affect an increase in the temperature of liquid in each pressure chamber, and heat generated by the piezoelectric element has a dominant role in an increase in the temperature of liquid in each pressure chamber 4. However, in the present embodiment, a piezoelectric material having a low piezoelectric constant and containing AlN, ScAlN, or the like as a main component is adopted as the piezoelectric element 5 as described above. Such a piezoelectric element 5 generates less heat (for example, about 1/10) during driving than a piezoelectric element made of a piezoelectric material having a high piezoelectric constant, such as PZT. Therefore, heat generated by the drive circuit 101, which is a heat generator other than the piezoelectric element, may affect an increase in the temperature of liquid in each pressure chamber.

The temperature of the liquid in each pressure chamber 4 rises as the heat of the drive circuit 101 is conducted via the pressure chamber substrate 100. However, since the pressure chambers 4 are densely formed, the liquid in each pressure chamber 4 is hardly affected by heat generated by the drive circuit 101 in a long-distance pressure chamber located at a distance not less than a predetermined distance from the drive circuit 101. Meanwhile, a short-distance pressure chamber located at a distance less than the predetermined distance from the drive circuit 101 is easily affected by heat generated by the drive circuit 101. Therefore, a difference between the temperatures of liquids in the long-distance pressure chamber and the short-distance pressure chamber, which are located at different distances from the drive circuit 101, tends to increase. Thus, the liquid discharge amount varies between the nozzles 2 corresponding to the long-distance pressure chamber and the short-distance pressure chamber.

The heat of each drive circuit 101 is conducted to liquid in the common chamber, which is formed on the pressure chamber substrate 100, via the pressure chamber substrate 100 to heat liquid located closer to the drive circuit 101, in the common chamber.

At this time, liquid in a short-distance region on both sides in the Y direction of the common chamber 3, the short-distance region being located at a short distance from the drive circuit 101, receives more heat from the drive circuit 101 than liquid in a long-distance region at the center in the Y direction of the common chamber 3, the long-distance region being located at a long distance from the drive circuit 101. The short-distance region is also referred to as a first region, and the long-distance region is also referred to as a second region.

Therefore, the temperature of the liquid in the short-distance region on both sides in the Y direction of the common chamber 3 is higher than the temperature of the liquid in the long-distance region at the center in the Y direction. As a result, the temperature of liquid flowing from the common chamber into the long-distance pressure chamber at the center in the Y direction becomes lower than the temperature of liquid flowing into the short-distance pressure chamber on the end side in the Y direction. Thus, a difference in liquid temperature between the long-distance pressure chamber and the short-distance pressure chamber further increases. This causes the liquid discharge amount to significantly vary between the nozzles 2 corresponding to the long-distance pressure chamber and the short-distance pressure chamber.

Therefore, the multiple extension portions 120a are provided as illustrated in FIG. 5B. The multiple extension portions 120a extend from one end of the common chamber 3 in the Y direction (lateral direction of the liquid discharge head) to the other end thereof in the Y direction (lateral direction of the liquid discharge head). As a result, the amount of heat transfer in the Y direction in the common chamber substrate 120 can be made larger than the amount of heat transfer in the X direction, which is the array direction of the drive circuits 101. As a result, heat is actively exchanged between the liquid in the short-distance region, where the liquid on both end sides in the Y direction of the common chamber 3 receives a larger amount of heat from the drive circuit, and the liquid in the long-distance region on the center side in the Y direction of the common chamber via the extension portion 120a. Thus, the temperature of the liquid can be made uniform in the common chamber 3. This makes it possible to reduce the difference between the temperature of the liquid flowing into the long-distance pressure chamber on the center side in the Y direction and the temperature of the liquid flowing into the short-distance pressure chamber on the end side in the Y direction. It is thus possible to reduce the difference between the temperature of the liquid in the long-distance pressure chamber and the temperature of the liquid in the short-distance pressure chamber.

As a result, it is possible to prevent the liquid discharge amount from varying between the nozzles 2 corresponding to the long-distance pressure chamber and the short-distance pressure chamber.

In addition, providing the extension portions 120a makes it possible to increase the area of contact with liquid in the common chamber, and to efficiently move the heat of the liquid in the common chamber. As a result, the temperature of the liquid in the common chamber 3 can be favorably uniformized.

The extension portions 120a extend from one end to the other end in the Y direction (lateral direction of the liquid discharge head). Meanwhile, for example, an extension portion 120a extending from one end in the Y direction to the center in the Y direction and an extension portion 120a extending from the other end in the Y direction to the center in the Y direction may be alternately arranged in the X direction. Even with such a configuration, heat exchange can be actively performed between the liquid on the end side in the Y direction of the common chamber 3 and the liquid on the center side in the Y direction of the common chamber 3 via the extension portions 120a. Thus, the temperature of the liquid can be made uniform in the common chamber 3.

The common chamber 3 formed in the common chamber substrate 120 is divided by the extension portions 120a. As a result, the extension portions 120a can prevent pressure waves of liquid in the pressure chamber 4 from propagating in the X direction through the common chamber 3 when the vibrating membrane 103 is vibrated by the piezoelectric element 5 of the nozzle plate 110. Accordingly, crosstalk can be prevented.

The extension portion 120a spans (is across) the opening 4a of each pressure chamber 4 in the Y direction. The extension portion 120a is across the opening 4a of each pressure chamber 4 in the Y direction. As a result, liquid in each pressure chamber comes into contact with the extension portion 120a via the opening 4a. Therefore, it is possible to perform heat exchange, via the extension portions 120a, between the liquid in the short-distance pressure chamber on the end side in the Y direction at a short distance from the drive circuit 101 and the liquid in the long-distance pressure chamber on the center side in the Y direction at a long distance from the drive circuit 101. As a result, it is possible to reduce the temperature difference between the liquid in the short-distance pressure chamber on the end side in the Y direction and the liquid in the long-distance pressure chamber on the center side in the Y direction.

### First Modification

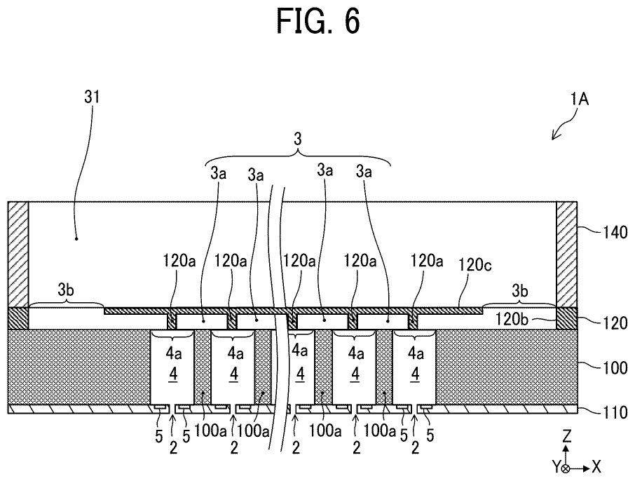

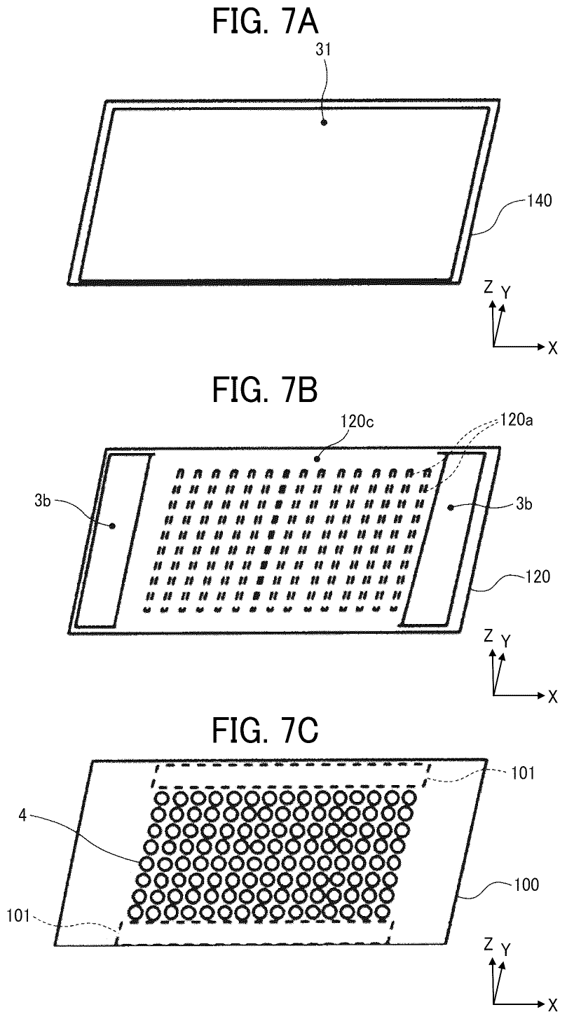

FIG. 6 is a schematic cross-sectional view of a liquid discharge head 1A according to a first modification. FIGS. 7A to 7C are schematic exploded views of the liquid discharge head 1A according to the first modification.

In the first modification, multiple common channel portions 3a, divided from each other by the extension portions 120a, are provided in the common chamber 3. The common chamber substrate 120 includes a ceiling wall 120c that closes the common chamber 3, on a side facing the frame 140. The extension portions 120a extend in the Y direction and span the opening 4a of each pressure chamber 4 of the pressure chamber substrate 100. The extension portions 120a extend in the Y direction and are across the opening 4a of each pressure chamber 4 of the pressure chamber substrate 100. The ceiling wall 120c and the extension portions 120a form the common channel portions 3a through which liquid flows along the extension portions 120a in the common chamber 3. A supply opening 3b is provided on both sides of the common chamber substrate 120 in the X direction (longitudinal direction of the liquid discharge head). The supply openings 3b each serve as a liquid supply portion through which liquid is supplied from the supply liquid storage chamber 31 of the frame 140.

At the time of continuous driving, liquid supplied from the supply liquid storage chamber 31 to the center side in the Y direction of the common chamber 3 may flow into the long-distance pressure chamber on the center side in the Y direction without sufficiently exchanging heat with liquid on the end side in the Y direction via the extension portions 120a.

Meanwhile, in the first modification, liquid supplied from the supply openings 3b to the common chamber flows from both sides of the common chamber in the Y direction to the common channel portions 3a. Then, the liquid flows in the common channel portions 3a toward the center side, and flows into the long-distance pressure chamber located on the center side. As described above, in the first modification, liquid that has flowed into the long-distance pressure chamber can be brought into contact with the extension portions 120a for a long period and sufficiently receive heat from the extension portions 120a to be substantially equal in temperature to the liquid in the short-distance region on the end side in the Y direction in the common chamber. This makes it possible to satisfactorily reduce the difference between the temperature of the liquid in the short-distance pressure chamber on the end side in the Y direction and the temperature of the liquid in the long-distance pressure chamber on the center side in the Y direction, even at the time of continuous driving.

Furthermore, in the first modification, it is possible to perform heat exchange between the liquid in the short-distance region on the end side in the Y direction of the common chamber 3 and the liquid in the long-distance region on the center side in the Y direction of the common chamber 3 via the ceiling wall 120c. This makes it possible to further uniformize the temperature of the liquid in the common chamber.

### Second Modification

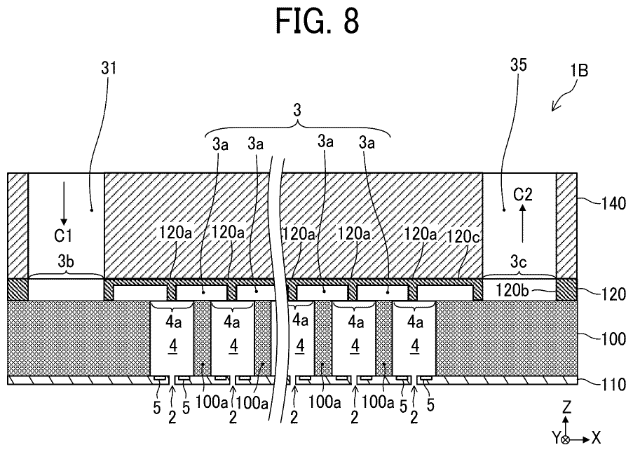

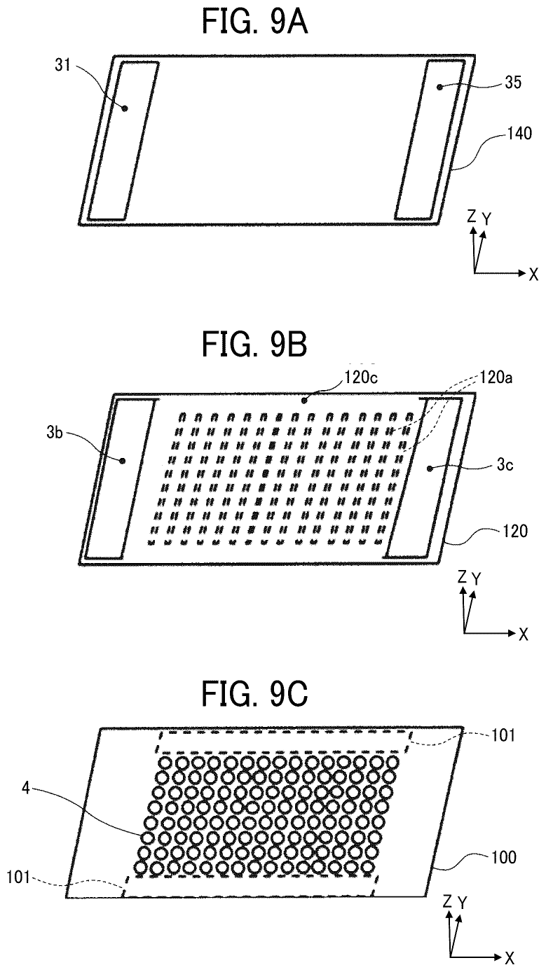

FIG. 8 is a schematic cross-sectional view of a liquid discharge head 1B according to a second modification. FIGS. 9A to 9C are schematic exploded views of the liquid discharge head 1B according to the second modification.

In the second modification, liquid in the liquid discharge head is circulated.

In the second modification, the frame 140 has the supply liquid storage chamber 31 and a discharged liquid storage chamber 35. The supply liquid storage chamber 31 is provided on one end side in the X direction (longitudinal direction of the liquid discharge head), and supplies liquid to the common chamber 3. The discharged liquid storage chamber 35 is provided on the other end side in the X direction, and liquid is discharged from the common chamber 3 to the discharged liquid storage chamber 35. The supply opening 3b is provided on one end side in the X direction of the common chamber 3. The supply opening 3b serves as a liquid supply portion through which liquid is supplied from the supply liquid storage chamber 31. A discharge opening 3c is provided on the other end side in the X direction. The discharge opening 3c serves as a liquid discharge portion through which liquid is discharged to the discharged liquid storage chamber 35. Except for this point, the configuration of the second modification is the same as the configuration of the first modification.

In the second modification, liquid supplied from the outside to the supply liquid storage chamber 31 of the frame 140 is supplied from the supply opening 3b to the common chamber as indicated by arrow C1 in FIG. 8. The liquid supplied to the common chamber 3 of the common chamber substrate 120 flows to the pressure chambers 4 via the common channel portions 3a in the same manner as in the first modification. When liquid flows into the pressure chamber 4 from one of the two common channel portions 3a communicating with the pressure chamber 4, liquid in the pressure chamber 4 is discharged to the other common channel portion 3a. Finally, the liquid flows into the discharged liquid storage chamber 35 from the discharge opening 3c, and is returned from the discharged liquid storage chamber 35 to the external liquid storage via an external pump or the like. As a result, liquid in the liquid discharge head 1 is circulated. Since the liquid in the liquid discharge head is circulated as described above, it is possible to prevent the liquid from staying in the pressure chamber 4 for a long period, to uniformize the temperature of the liquid in the liquid discharge head, and to reduce a difference between the temperature of the liquid in the long-distance pressure chamber on the center side in the Y direction and the temperature of the liquid in the short-distance pressure chamber on the end side in the Y direction.

Furthermore, circulation of the liquid in the liquid discharge head makes it possible to eliminate air bubbles present in flow paths in the liquid discharge head 1, such as the common chamber 3 and the pressure chambers 4. In addition, in the case of using a liquid containing a component that is likely to settle, it is also possible to prevent the component of the liquid from settling in the liquid chamber in the liquid discharge head 1.

### Third Modification

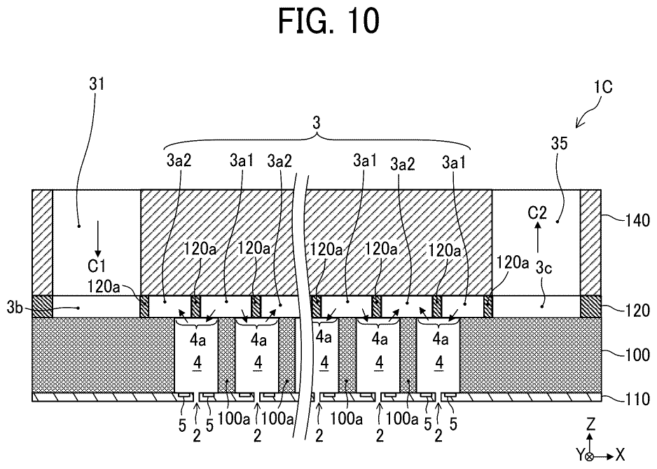

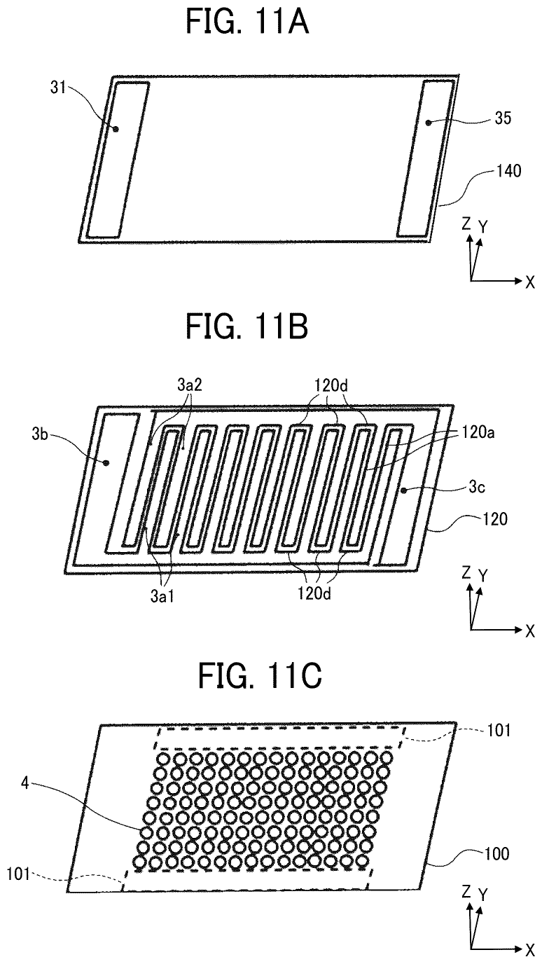

FIG. 10 is a schematic cross-sectional view of a liquid discharge head 1C according to a third modification. FIGS. 11A to 11C are schematic exploded views of the liquid discharge head 1C according to the third modification.

In the third modification, the common chamber includes supply common channel portions 3a1 and discharge common channel portions 3a2. The supply common channel portions 3a1 each supply liquid to the pressure chambers. Liquid is discharged from the pressure chambers to the discharge common channel portions 3a2.

As illustrated in FIG. 11B, the supply common channel portions 3a1 and the discharge common channel portions 3a2 each have a comb-teeth shape, and are disposed such that the respective comb-teeth portions of the supply common channel portions 3a1 and the discharge common channel portions 3a2 are fitted into each other.

Both ends in the Y direction of the extension portions 120a extending in the Y direction and arranged at regular intervals in the X direction are coupled to each other by partition walls 120d. With such a configuration, one of the spaces divided by the extension portions 120a and the partition walls 120d forms the supply common channel portion 3a1, and the other space forms the discharge common channel portion 3a2.

According to the third modification, it is possible to create a flow for allowing liquid to flow into the opening 4a of the pressure chamber 4 from the supply common channel portion 3a1 and a flow for allowing liquid to flow out to the discharge common channel portion 3a2. Thus, it is possible to create, for the pressure chamber 4, a flow for letting liquid in and out. As a result, the movement of liquid in the liquid discharge head can be activated as compared with the second modification. It is thus possible to satisfactorily prevent liquid from staying in the common chamber 3 or the pressure chamber 4. As a result, the temperature of the liquid in the liquid discharge head can be made uniform as compared with the second modification. It is thus possible to favorably prevent the liquid discharge amount from varying between the nozzles 2.

Furthermore, the movement of liquid in the pressure chamber 4 is activated in the third modification. Therefore, air bubbles in the pressure chamber 4 are easily moved and discharged from the pressure chamber 4. As a result, the occurrence of discharge failure can also be prevented.

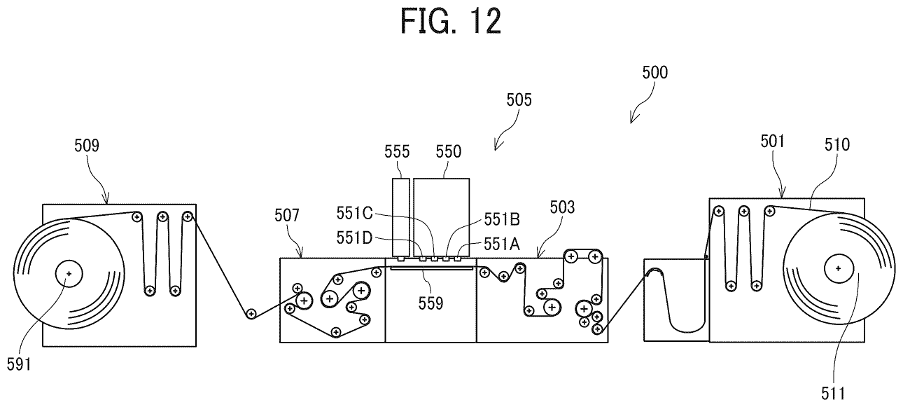

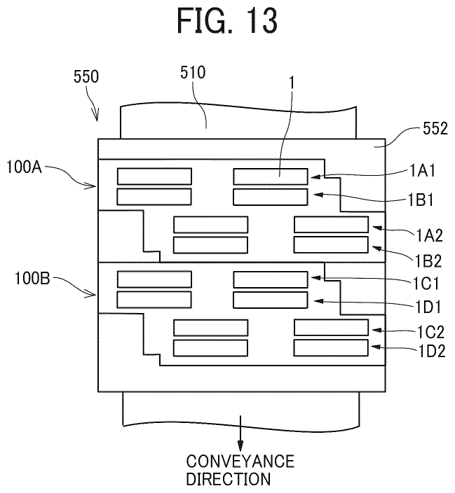

Next, an example of the liquid discharge apparatus will be described with reference to FIGS. 12 and 13.

FIG. 12 is a schematic explanatory diagram illustrating a printing apparatus that is an inkjet recording apparatus that is an image forming apparatus serving as the liquid discharge apparatus.

FIG. 13 is an explanatory diagram illustrating a plan view of an example of a head device of the printing apparatus.

A printing apparatus 500, which is a liquid discharge apparatus, includes a feeder 501 that carries a continuous medium 510, and a guide conveyor 503 that guides and conveys the continuous medium 510 carried in from the feeder 501 to a printing unit 505. The printing apparatus 500 also includes the printing unit 505 that performs printing for discharging liquid onto the continuous medium 510 to form an image, a dryer 507 that dries the continuous medium 510, and an ejector 509 that carries out the continuous medium 510.

The continuous medium 510 is fed from a winding roller 511 of the feeder 501, guided and conveyed with rollers of the feeder 501, the guide conveyor 503, the dryer 507, and the ejector 509, and wound around a take-up roller 591 of the ejector 509. In the printing unit 505, the continuous medium 510 is conveyed on a conveyance guide 559 in such a way as to face head devices 550 and 555. The head devices 550 and 555 discharge liquid from the nozzles of liquid discharge heads 1 to form an image on the continuous medium 510.

In the printing apparatus 500, the head devices 550 and 555 include two head modules 100A and 100B according to the present embodiment described above on a common base member 552. The head device 550 includes head units 551A, 551B, 551C, and 551D, each discharges liquids of different colors.

As illustrated in FIG. 13, the head module 100A includes head arrays 1A1, 1B1, 1A2, and 1B2. Each of the head arrays 1A1, 1B1, 1A2, and 1B2 includes multiple liquid discharge heads 1 arranged in a head array direction perpendicular to a conveyance direction of a sheet P indicated by an arrow in FIG. 13. The head module 100B includes head arrays 1C1, 1D1, 1C2, and 1D2. Each of the head arrays 1C1, 1D1, 1C2, and 1D2 includes multiple liquid discharge heads 1 arranged in the head array direction perpendicular to the conveyance direction of the sheet P. The multiple liquid discharge heads 1 in each of the head arrays 1A1 and 1A2 of the head module 100A discharge liquid of the same desired color. Similarly, the head arrays 1B1 and 1B2 of the head module 100A function as a set of head arrays that discharge liquid of the same desired color. The head arrays 1C1 and 1C2 of the head module 100B function as a set of head arrays that discharge liquid of the same desired color. The head arrays 1D1 and 1D2 of the head module 100B function as a set of head arrays that discharge liquid of the same desired color.

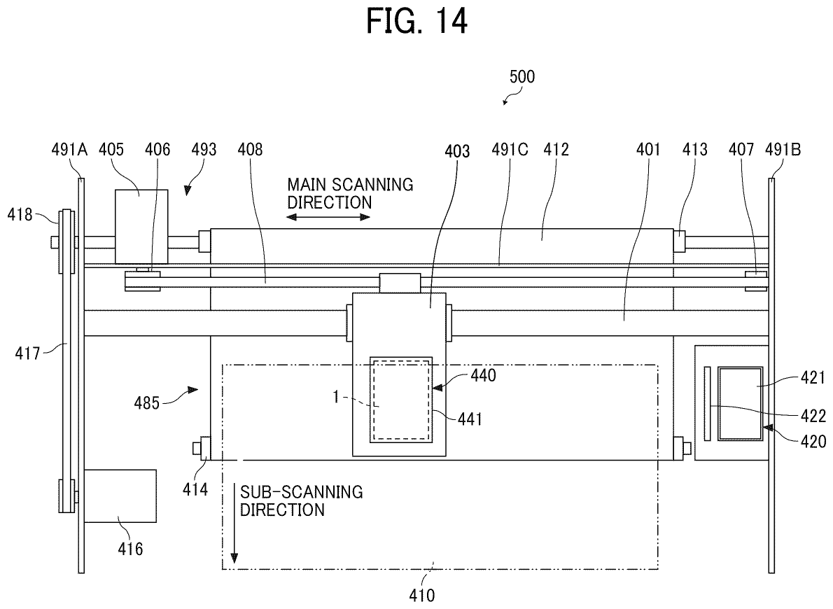

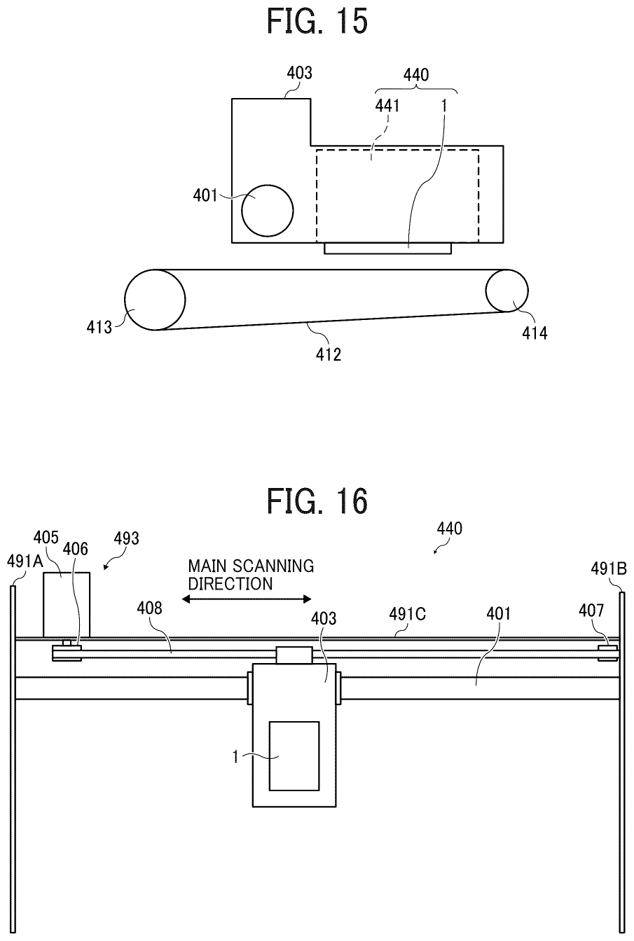

Next, another example of the printing apparatus serving as the liquid discharge apparatus will be described with reference to FIGS. 14 and 15.

FIG. 14 is an explanatory diagram illustrating a plan view of a main part of a printing apparatus of the present example.

FIG. 15 is an explanatory diagram illustrating a side view of the main part of the printing apparatus of the present example.

The printing apparatus 500 is a serial type inkjet recording apparatus, and a carriage 403 reciprocates in a main scanning direction indicated by arrow “MSD” in FIG. 14 using a main scan moving unit 493. The main scan moving unit 493 includes a guide 401, a main scan motor 405, a timing belt 408, and the like. The guide 401 is bridged between a left-side plate 491A and a right-side plate 491B to movably hold the carriage 403.

The main scan motor 405 causes the carriage 403 to reciprocate in the main scanning direction MSD via the timing belt 408 bridged between a drive pulley 406 and a driven pulley 407.

The carriage 403 is equipped with a liquid discharge device 440. The liquid discharge head 1 and a head tank 441 form the liquid discharge device 440 as a single unit.

The liquid discharge head 1 of the liquid discharge device 440 discharges liquid of each color, for example, yellow (Y), cyan (C), magenta (M), and black (K).

The liquid discharge head 1 includes a nozzle array including multiple nozzles arrayed in a sub-scanning direction as indicated by arrow “SSD”. The sub-scanning direction is orthogonal to the main scanning direction, MSD. The liquid discharge head 1 is mounted on the carriage 403 such that ink droplets are discharged downward. The liquid discharge head 1 is coupled to a liquid circulation device, and liquids of desired colors are circulated and supplied.

The printing apparatus 500 includes a conveyor 485 to convey a sheet 410. The conveyor 485 includes a conveyance belt 412 as a conveyor and a sub-scanning motor 416 to drive the conveyance belt 412. The conveyance belt 412 attracts the sheet 410 and conveys the sheet 410 to a position facing the liquid discharge head 1. The conveyance belt 412 is an endless belt stretched between a conveyance roller 413 and a tension roller 414. Attraction of the sheet 410 to the conveyance belt 412 may be applied by electrostatic adsorption, air suction, or the like. The conveyance belt 412 rotates in the sub-scanning direction SSD as the conveyance roller 413 is rotationally driven by the sub scan motor 416 via a timing belt 417 and a timing pulley 418.

On one side in the main scanning direction MSD of the carriage 403, a maintenance unit 420 to maintain the liquid discharge head 1 in good condition is disposed on a lateral side of the conveyance belt 412. The maintenance unit 420 includes, for example, a cap 421 to cap the nozzle surface of the liquid discharge head 1, and a wiper 422 to wipe the nozzle surface of the liquid discharge head 1. The main scan moving unit 493, the maintenance unit 420, and the conveyor 485 are mounted onto a housing including the left-side plate 491A, the right-side plate 491B, and a back plate 491C.

In the printing apparatus 500 thus configured, the sheet 410 is conveyed on and attracted to the conveyance belt 412, and is conveyed in the sub scanning direction SSD by a cyclic rotation of the conveyance belt 412. The liquid discharge head 1 is driven in response to image signals while the carriage 403 is moving in the main scanning direction MSD, to discharge liquid to the sheet 410 stopped, thus forming an image on the sheet 410.

Next, another example of the liquid discharge device will be described with reference to FIG. 16.

FIG. 16 is an explanatory diagram illustrating a plan view of a main part of a liquid discharge device of the present example.

The liquid discharge device 440 includes a housing, the main scan moving unit 493, the carriage 403, and the liquid discharge head 1 among components of the liquid discharge apparatus. The left-side plate 491A, the right-side plate 491B, and the back plate 491C form the housing.

Note that, in the liquid discharge device 440, the maintenance unit 420 described above may be mounted on the right-side plate 491B, for example.

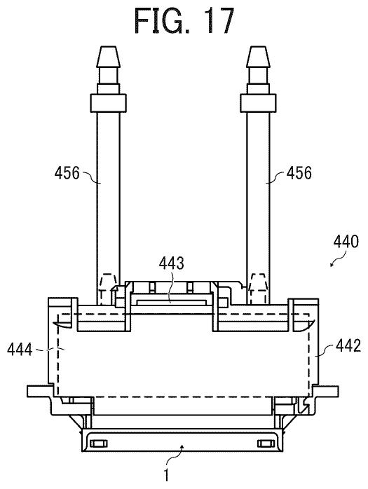

Next, still another example of the liquid discharge device will be described with reference to FIG. 17.

FIG. 17 is an explanatory diagram illustrating a front view of a liquid discharge device of the present example.

The liquid discharge device 440 includes the liquid discharge head 1 to which a channel part 444 is attached, and tubes 456 coupled to the channel part 444.

The channel part 444 is disposed inside a cover 442. Instead of the channel part 444, the liquid discharge device 440 may include the head tank 441. A connector 443 that electrically connects to the liquid discharge head 1 is provided on an upper part of the channel part 444.

Liquid to be discharged from the nozzles of the head is not limited to a particular liquid as long as the liquid has a viscosity or surface tension to be discharged from the head. However, preferably, the viscosity of the liquid is not greater than 30 mPa·s under ordinary temperature and ordinary pressure or by heating or cooling. Examples of the liquid include a solution, a suspension, or an emulsion that contains, for example, a solvent, such as water or an organic solvent, a colorant, such as dye or pigment, a functional material, such as a polymerizable compound, a resin, or a surfactant, a biocompatible material, such as DNA, amino acid, protein, or calcium, or an edible material, such as a natural colorant. Examples of the liquid also include molten metal such as solder. Such a solution, a suspension, an emulsion, or molten metal can be used for, e.g., inkjet ink, surface treatment solution, a liquid for forming components of an electronic element or light-emitting element or a resist pattern of an electronic circuit, a liquid for forming solder bumps, or a material solution for three-dimensional fabrication.

The “liquid discharge device”is an assembly of parts relating to liquid discharge. The term “liquid discharge device” represents a structure including the liquid discharge head and a functional part(s) or unit(s) combined to the liquid discharge head to form a single unit. For example, the “liquid discharge device” includes a combination of the liquid discharge head with at least one of a head tank, a carriage, a supply unit, a maintenance unit, a main scan moving unit, and a liquid circulation device.

Examples of the “single unit” include a combination in which the liquid discharge head and one or more functional parts and units are secured to each other through, e.g., fastening, bonding, or engaging, and a combination in which one of the liquid discharge head and the functional parts and units is movably held by another. The liquid discharge head and the functional part(s) or unit(s) may be detachably attached to each other.

For example, the liquid discharge head and the head tank may form the liquid discharge device as a single unit. Alternatively, the liquid discharge head and the head tank coupled (connected) with a tube or the like may form the liquid discharge device as a single unit. A unit including a filter may be added at a position between the head tank and the liquid discharge head of the liquid discharge device.

In another example, the liquid discharge head and the carriage may form the liquid discharge device as a single unit.

In still another example, the liquid discharge device includes the liquid discharge head movably held by a guide that forms part of a main scan moving unit, so that the liquid discharge head and the main scan moving unit form a single unit. The liquid discharge device may include the liquid discharge head, the carriage, and the main scan moving unit that form a single unit.

In still another example, a cap that forms a part of the maintenance unit may be secured to the carriage equipped with the liquid discharge head so that the liquid discharge head, the carriage, and the maintenance unit form a single unit to form the liquid discharge device.

Furthermore, in still another example, the liquid discharge device includes tubes coupled to the head tank or the liquid discharge head with a channel part mounted thereon so that the liquid discharge head and the supply unit form a single unit. A liquid in a liquid reservoir source such as an ink cartridge is supplied to the liquid discharge head through this tube.

The main scan moving unit may be a guide only. The supply unit may be a tube(s) only or a loading unit only.

The “liquid discharge device” includes a head module including the above-described liquid discharge head, and a head device in which the above-described functional components and mechanisms are combined to form a single unit.

The term “liquid discharge apparatus” used herein also represents an apparatus including the liquid discharge head, the liquid discharge device, the head module, the head device, and the liquid discharge device to discharge liquid by driving the liquid discharge head. The liquid discharge apparatus may be, for example, an apparatus that can discharge a liquid to a material to which liquid can adhere or an apparatus to discharge liquid toward gas or into liquid.

The “liquid discharge apparatus” may include devices to feed, convey, and eject the material to which liquid can adhere. The “liquid discharge apparatus” may further include a pretreatment apparatus to coat the material with a treatment liquid, and a post-treatment apparatus to coat the material with a treatment liquid, the liquid having been discharged onto the material.

The “liquid discharge apparatus” may be, for example, an image forming apparatus to form an image on a sheet by discharging ink, or a three-dimensional fabrication apparatus to discharge a fabrication liquid to a powder layer in which powder material is formed in layers to form a three-dimensional fabrication object.

The “liquid discharge apparatus” is not limited to an apparatus to discharge liquid to visualize meaningful images, such as letters or figures. For example, the “liquid discharge apparatus” may be an apparatus to form meaningless images, such as meaningless patterns, or fabricate three-dimensional images.

The above-described term “material to which liquid can adhere” refers to a material to which liquid can adhere at least temporarily, a material to which liquid adheres and sticks, or a material to be permeated by liquid that adheres thereto. Examples of the “material to which liquid can adhere” include recording media, such as a paper sheet, recording paper, a recording sheet of paper, a film, and cloth, electronic components, such as an electronic substrate and a piezoelectric element, and media, such as a powder layer, an organ model, and a testing cell. The “material to which liquid can adhere” includes any material to which liquid can adhere, unless particularly limited.

Examples of the “material to which liquid can adhere” include any materials to which liquid can adhere even temporarily, such as paper, thread, fiber, fabric, leather, metal, plastic, glass, wood, and ceramics.

The “liquid discharge apparatus” may be an apparatus in which the liquid discharge head and a material to which liquid can adhere move relative to each other. However, the “liquid discharge apparatus” is not limited to such an apparatus. For example, the liquid discharge apparatus may be a serial head apparatus that moves the liquid discharge head or a line head apparatus that does not move the liquid discharge head.

Examples of the “liquid discharge apparatus” further include a treatment liquid coating apparatus to discharge a treatment liquid to a sheet so as to coat a surface of the sheet with the treatment liquid for the purpose of reforming the surface of the sheet. Furthermore, examples of the “liquid discharge apparatus” also include an injection granulation apparatus that sprays a composition liquid containing raw materials dispersed in a solution through a nozzle to granulate fine particles of the raw materials.

The terms “image formation”, “recording”, “printing”, “image printing”, and “fabricating” are used herein synonymously with each other.

A liquid discharge head includes: a nozzle plate having multiple nozzles to discharge a liquid, the multiple nozzles arrayed in a first direction and a second direction intersecting the first direction; a pressure chamber substrate on the nozzle plate, the pressure chamber substrate having multiple pressure chambers respectively communicating with the multiple nozzles; multiple actuators, respectively disposed at the multiple nozzles, in the nozzle plate, the multiple actuators to respectively discharge the liquid in the multiple pressure chambers from the multiple nozzles; and a common chamber substrate on the pressure chamber substrate, the common chamber substrate having a common chamber communicating with each of the multiple pressure chambers; a heat generator at one side of the common chamber in the first direction; a first region in a vicinity of the heat generator in the common chamber in the first direction; a second region at a center of the common chamber in the first direction; and an extension portion extending from the first region to the second region in the first direction in the common chamber.

The heat generator is at one end, in the first direction, of: the pressure chamber substrate; or the nozzle plate, and the extension portion extends from the first region to the second region in the first direction. The heat generator is at both ends, in the first direction, of: the pressure chamber substrate; or the nozzle plate, and the extension portion extends from one end to another end of the common chamber in the first direction.

The multiple nozzles discharge the liquid in a discharge direction, the multiple pressure chambers respectively have multiple openings at a first face of the pressure chamber substrate facing the common chamber substrate in the discharge direction, the first face is opposite to a second face of the pressure chamber substrate facing the nozzle plate in the discharge direction, the common chamber faces each of the multiple openings, and the extension portion spans the multiple openings of the multiple pressure chambers.

The liquid discharge head includes: multiple extension portions including the extension portion. The common chamber includes multiple common channels, the multiple nozzles to discharge the liquid in a discharge direction, the multiple pressure chambers respectively have multiple openings at a first face of the pressure chamber substrate facing the common chamber substrate in the discharge direction, the first face is opposite to a second face of the pressure chamber substrate facing the nozzle plate in the discharge direction, the common chamber faces each of the multiple openings, and the multiple extension portions respectively partition the multiple common channels.

The liquid discharge head includes: a ceiling wall covering the multiple openings in the discharge direction. The multiple extension portions respectively include multiple ribs: coupled to the ceiling wall; and projected from the ceiling wall to the pressure chamber substrate. The common chamber substrate includes: a liquid supply portion to supply the liquid to the common chamber; and a liquid discharge portion to discharge the liquid from the common chamber.

The multiple extension portions span the multiple pressure chambers, the multiple extension portions partition the multiple common channels, the multiple common channels include: a liquid supply portion to supply the liquid to the multiple pressure chambers; and a liquid discharge portion to discharge the liquid from the multiple pressure chambers.

A liquid discharge head includes: a nozzle plate having multiple nozzles to discharge a liquid, the multiple nozzles arrayed in a first direction and a second direction intersecting the first direction; a pressure chamber substrate on the nozzle plate, the pressure chamber substrate having multiple pressure chambers respectively communicating with the multiple nozzles; multiple actuators, respectively disposed at the multiple nozzles, in the nozzle plate, the multiple actuators to respectively discharge the liquid in the multiple pressure chambers from the multiple nozzles; and a common chamber substrate on the pressure chamber substrate, the common chamber substrate having a common chamber communicating with each of the multiple pressure chambers; and multiple heat generators at both sides, in the first direction, of: the pressure chamber substrate; or the nozzle plate, the multiple heat generators arrayed in the second direction; and an extension portion to transfer a first amount of heat generated from the multiple heat generators in the common chamber in the first direction. The extension portion transfers a second amount of the heat smaller than the first amount in the common chamber in the second direction.

The common chamber substrate includes silicon. The heat generator includes a drive circuit to drive the multiple actuators. The drive circuit drives the multiple actuators. The drive circuit is: disposed in the nozzle plate; or disposed in the pressure chamber substrate. A liquid discharge apparatus includes a liquid discharge head; and a conveyor to convey a medium to the liquid discharge head, and the liquid discharge head discharges the liquid onto the medium conveyed by the conveyor.

The liquid discharge head further includes: multiple extension portion including the extension portion, each of the multiple extension portion extending from one end to another end of the common chamber in the first direction; and multiple heat generators including the heat generator, multiple heat generators at both ends, in the first direction, of: the pressure chamber substrate; or the nozzle plate. The multiple extension portions transfer a first amount of heat generated from the multiple heat generators in the common chamber in the first direction, and the multiple extension portions transfer a second amount of the heat smaller than the first amount in the common chamber in the second direction.

The extension portion includes a continuous wall extending in the first direction. The extension portion includes an intermittent wall arrayed in the first direction. The common chamber substrate has supply openings, at both ends of the common chamber substrate in the second direction, to supply the liquid to the common chamber. The liquid discharge head includes: two heat generators at both ends of the common chamber substrate in the first direction, and the multiple nozzles are disposed between the two heat generators in the first direction.

The common chamber substrate includes: a common supply channel to supply the liquid to the common chamber; and a common discharge channel to discharge the liquid from the common chamber, and the common supply channel has first interlocking teeth, the common discharge channel has second interlocking teeth, and the first interlocking teeth and the second interlocking teeth are interlocked with each other.

According to the present embodiment, it is possible to prevent variations in the amount of liquid to be discharged from nozzles.

The above-described embodiment and modifications are limited examples, and the present disclosure includes, for example, the following aspects having advantageous effects.

### Aspect 1

According to Aspect 1, a liquid discharge head 1 includes: a nozzle plate 110 having multiple nozzles 2 that discharge liquid; a pressure chamber substrate 100 having multiple pressure chambers 4 each communicating with corresponding one of the multiple nozzles 2; multiple actuators such as piezoelectric elements 5, each of the actuators being provided for corresponding one of the multiple pressure chambers 4; and a common chamber substrate 120 having a common chamber 3 communicating with each of the multiple pressure chambers 4, the liquid discharge head 1 being configured to drive the actuators to discharge the liquid in the pressure chambers 4 from the nozzles 2, wherein the liquid discharge head 1 includes: a heat generator such as a drive circuit 101; and an extension portion 120a extending from a region (corresponding to a near region at a short distance from the drive circuit on both end sides of the common chamber in the Y direction) in the common chamber in which the liquid receives a large amount of heat from the heat generator to a region (corresponding to a long-distance region at a long distance from the drive circuit at the center of the common chamber in the Y direction in the present embodiment) in the common chamber 3 in which the liquid receives a smaller amount of heat from the heat generator than in the region.

The drive circuit generates heat when the actuators are driven. The heat of the drive circuit serving as a heat generator is conducted to liquid in the common chamber through the pressure chamber substrate, and the liquid in the common chamber is heated. At this time, liquid in the short-distance region in the common chamber, located closer to the drive circuit receives more heat from the drive circuit than liquid in the long-distance region in the common chamber, at a longer distance from the drive circuit. Thus, the temperature of the liquid in the short-distance region in the common chamber may be higher than the temperature of the liquid in the long-distance region. This may cause a difference in liquid temperature between the pressure chamber into which the liquid in the short-distance region in the common chamber flows and the pressure chamber into which the liquid in the long-distance region flows. In general, the viscosity of liquid such as ink to be used in a liquid discharge head varies depending on the temperature. Therefore, when the temperature of liquid in the pressure chamber into which the liquid in the short-distance region in the common chamber flows is different from the temperature of liquid in the pressure chamber into which the liquid in the long-distance region flows, the viscosities of the liquids are different from each other, and there is a possibility that the amounts of liquid to be discharged from the nozzles vary.

In Aspect 1, it is possible to actively perform heat exchange between liquid located in a region of the common chamber in which the liquid receives a larger amount of heat from the heat generator and a liquid located in a region of the common chamber in which the liquid receives a less amount of heat from the heat generator, via the extension portion. Thus, the temperature of liquid can be made uniform in the common chamber. The temperature of liquid can be made uniform in the common chamber in this manner. Thus, it is possible to prevent a difference from being made between temperatures of liquids flowing to the pressure chambers, and it is possible to prevent variations in the amounts of liquid to be discharged from the nozzles.

### Aspect 2

According to Aspect 2, in the liquid discharge head 1 of Aspect 1, the heat generator such as the drive circuit 101 is provided at one end of the pressure chamber substrate 100 or one end of the nozzle plate 110, and the extension portion 120a extends from at least an end of the inside of the common chamber 3 on a side where the heat generator is disposed, the extension portion 120a extending in a direction perpendicular to a side wall portion 120b of the common chamber 3, the side wall portion 120b being located on the side where the heat generator is disposed.

According to this aspect, it is possible to actively exchange heat, via the extension portion 120a, between the liquid in the common chamber 3 on the side where the heat generator such as the drive circuit 101 is disposed, that is, the liquid in the common chamber 3 located closer to the heat generator, and the liquid in the region of the common chamber 3 at a predetermined distance in the vertical direction (Y direction) from the side wall portion 120b on the side where the heat generator is disposed, that is, the liquid in the region of the common chamber 3 where the liquid receives a less amount of heat from the heat generator, as described in the embodiment. Thus, it is possible to uniformize the temperature of liquid in the common chamber.

### Aspect 3

According to Aspect 3, in the liquid discharge head 1 of Aspect 1 or 2, the heat generator such as the drive circuit 101 is provided at both ends of the nozzle plate 110 or both ends of the pressure chamber substrate 100, and the extension portion 120a extends from a side where one of the two heat generators is disposed to a side where another of the two heat generators is disposed.

According to this aspect, it is possible to actively exchange heat, via the extension portion 120a, between the liquid in the common chamber 3 on the side where the heat generator such as the drive circuit 101 is disposed, that is, the liquid in the common chamber 3 located closer to the heat generator, and the liquid in the region of the common chamber 3 at a predetermined distance in the vertical direction (Y direction) from the side wall portion 120b on the side where the heat generator is disposed, that is, the liquid in the region of the common chamber 3 where the liquid receives a less amount of heat from the heat generator, as described in the embodiment. Thus, it is possible to uniformize the temperature of liquid in the common chamber.

### Aspect 4

According to Aspect 4, in the liquid discharge head 1 of Aspect 3, the common chamber 3 faces each of openings 4a of the multiple pressure chambers 4, the openings 4a being located on a side facing nozzle forming walls of the multiple pressure chambers 4, and the extension portion is disposed in such a way as to straddle the pressure chamber 4.

According to this aspect, liquid in each pressure chamber 4 can come into contact with the extension portion 120a via liquid in the opening 4a to perform, via the extension portion, heat exchange between liquid in a short-distance pressure chamber located on the side where the heat generator such as the drive circuit 101 is disposed and liquid in a long-distance pressure chamber at a predetermined distance from the heat generator as described in the embodiment. Thus, it is possible to reduce a temperature difference between the liquid in the short-distance pressure chamber and the liquid in the long-distance pressure chamber.

### Aspect 5

According to Aspect 5, in the liquid discharge head 1 of Aspect 3 or 4, the common chamber 3 faces each of openings 4a of the multiple pressure chambers 4, the openings 4a being located on a side facing nozzle forming walls of the multiple pressure chambers 4, and the common chamber 3 includes multiple common channel portions 3a divided from each other by the extension portion 120a, the multiple common channel portions 3a allowing the liquid to flow along the extension portion 120a.

According to this aspect, liquid in the common chamber enters the common channel portion 3a from the side where the heat generator such as the drive circuit 101 is disposed, moves in the common channel portion 3a along the extension portion 120a, and then, flows into the long-distance pressure chamber on the center side in the Y direction at a predetermined distance from the heat generator such as the drive circuit 101, as described in the first modification. As a result, even at the time of continuous driving, it is possible to cause liquid having risen to a temperature substantially the same as the temperature of the liquid in the common chamber 3 on the side where the heat generator is disposed as a result of receiving heat from the extension portion 120a for a long period of time, to flow into the long-distance pressure chamber. As a result, it is possible to reduce a difference in temperature between the short-distance pressure chamber and the long-distance pressure chamber at the time of continuous driving. Thus, it is possible to prevent the liquid discharge amount from varying between the nozzles 2.

### Aspect 6

According to Aspect 6, the liquid discharge head 1 of Aspect 5 further includes a ceiling wall 120c closing the common channel portions 3a on a side opposite to the openings 4a.

According to this aspect, heat exchange is performed on liquid in the common chamber via the ceiling wall 120c, so that the temperature of the liquid in the common chamber can be favorably uniformized, as described in the first modification.

### Aspect 7

According to Aspect 7, in the liquid discharge head 1 of Aspect 5 or 6, the common chamber substrate 120 has: a liquid supply portion such as a supply opening 3b through which the liquid is supplied to the common chamber 3; and a liquid discharge portion such as a discharge opening 3c through which the liquid is discharged from the common chamber 3.

According to this aspect, liquid in the liquid discharge head can be circulated, and can be prevented from staying in the pressure chamber 4 or the like, as described in the second modification. As a result, the temperature of liquid in the liquid discharge head can be made uniform, and it is thus possible to prevent the liquid discharge amount from varying between the nozzles 2.

Furthermore, circulation of the liquid in the liquid discharge head makes it possible to eliminate air bubbles present in flow paths in the liquid discharge head 1, such as the common chamber 3 and the pressure chambers 4. In addition, in the case of using a liquid containing a component that is likely to settle, it is also possible to prevent the component of the liquid from settling in the liquid chamber in the liquid discharge head 1.

### Aspect 8

According to Aspect 8, in the liquid discharge head 1 of Aspect 7, the extension portion 120a is disposed in such a way as to straddle the pressure chamber 4, some of the multiple common channel portions divided from each other by the extension portion 120a each serve as a supply common channel portion 3a1 that supplies the liquid to the pressure chamber 4, and a rest of the multiple common channel portions each serve as a discharge common channel portion 3a2 that discharges the liquid from the pressure chamber 4.

According to this aspect, it is possible to create a flow for allowing liquid to flow into the opening 4a of the pressure chamber 4 from the supply common channel portion 3a1 and a flow for allowing liquid to flow out to the discharge common channel portion 3a2. Thus, it is possible to create, for the pressure chamber 4, a flow for letting liquid in and out, as described in the third modification. As a result, movement of liquid in the liquid discharge head can be activated. It is thus possible to satisfactorily prevent liquid from staying in the common chamber 3 or the pressure chamber 4. As a result, the temperature of the liquid in the liquid discharge head can be made uniform as compared with the second modification. It is thus possible to favorably prevent the liquid discharge amount from varying between the nozzles 2.

### Aspect 9

According to Aspect 9, a liquid discharge head 1 includes: a nozzle plate 110 having multiple nozzles 2 that discharge liquid; a pressure chamber substrate 100 having multiple pressure chambers 4 each communicating with corresponding one of the multiple nozzles 2; multiple actuators such as piezoelectric elements 5, each of the actuators being provided for corresponding one of the multiple pressure chambers 4; and a common chamber substrate 120 having a common chamber 3 communicating with each of the multiple pressure chambers 4, the liquid discharge head 1 being configured to drive the actuators to discharge the liquid in the pressure chambers 4 from the nozzles 2, wherein multiple heat generators, such as drive circuits 101, is arrayed in a predetermined direction (X direction), and the common chamber substrate 120 transfers a larger amount of heat in an orthogonal direction (Y direction) orthogonal to an array direction of the heat generators than in the array direction (X direction) of the heat generators.

According to this aspect, unevenness in temperature in the common chamber increases in the orthogonal direction (Y direction) of the common chamber 3, orthogonal to the array direction of the heat generators such as the drive circuit 101, as described in the embodiment.

In Aspect 8, since the amount of heat transfer in the orthogonal direction (Y direction) orthogonal to the array direction is large, heat exchange is actively performed between liquids in the common chamber via the common chamber substrate in the orthogonal direction (Y direction). Thus, the temperature of liquid in the common chamber 3 can be favorably uniformized.

### Aspect 10

According to Aspect 10, in the liquid discharge head 1 of any one of Aspects 1 to 9, the common chamber substrate 120 includes silicon.

According to this aspect, as described in the embodiment, micromachining can be easily performed, and high thermal conductivity can be obtained. Thus, heat exchange can be efficiently performed between liquids in the common chamber, to allow temperature in the common chamber to be favorably uniformized.

### Aspect 11

According to Aspect 11, in the liquid discharge head 1 of any one of Aspects 1 to 10, the heat generator is the drive circuit 101 that drives the actuator such as the piezoelectric element 5.

According to this aspect, it is possible to prevent the liquid discharge amount from varying between the nozzles 2 due to the influence of heat generated by the drive circuit 101.

### Aspect 12

According to Aspect 12, in the liquid discharge head 1 of Aspect 11, the drive circuit 101 drives the multiple actuators such as the piezoelectric elements 5.

According to this aspect, the number of drive circuits can be reduced as compared with a case where the drive circuit 101 drives only a single actuator.

### Aspect 13

According to Aspect 13, in the liquid discharge head 1 of Aspect 11 or 12, the drive circuit 101 is provided on the nozzle plate 110 or the pressure chamber substrate 100.

According to this aspect, wiring to the actuator provided on the nozzle plate 110 can be easily performed.

### Aspect 14

According to Aspect 14, in a liquid discharge apparatus including a liquid discharge head 1, the liquid discharge head of any one of Aspects 1 to 13 is used as the liquid discharge head 1.

According to this aspect, the temperature of liquid can be made uniform in the common chamber.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having multiple nozzles to discharge a liquid, the multiple nozzles arrayed in a first direction and a second direction intersecting the first direction;
a pressure chamber substrate on the nozzle plate, the pressure chamber substrate having multiple pressure chambers respectively communicating with the multiple nozzles;
multiple actuators, respectively disposed at the multiple nozzles, in the nozzle plate, the multiple actuators to respectively discharge the liquid in the multiple pressure chambers from the multiple nozzles; and
a common chamber substrate on the pressure chamber substrate, the common chamber substrate having a common chamber communicating with each of the multiple pressure chambers;
a heat generator at one side of the common chamber in the first direction;
a first region in a vicinity of the heat generator in the common chamber in the first direction;
a second region at a center of the common chamber in the first direction; and
an extension portion extending from the first region to the second region in the first direction in the common chamber.

2. The liquid discharge head according to claim 1,
wherein the heat generator is at one end, in the first direction, of:
the pressure chamber substrate; or
the nozzle plate, and
the extension portion extends from the first region to the second region in the first direction.

3. The liquid discharge head according to claim 1,
wherein the heat generator is at both ends, in the first direction, of:
the pressure chamber substrate; or
the nozzle plate, and
the extension portion extends from one end to another end of the common chamber in the first direction.

4. The liquid discharge head according to claim 3,
wherein the multiple nozzles discharge the liquid in a discharge direction,
the multiple pressure chambers respectively have multiple openings at a first face of the pressure chamber substrate facing the common chamber substrate in the discharge direction,
the first face is opposite to a second face of the pressure chamber substrate facing the nozzle plate in the discharge direction,
the common chamber faces each of the multiple openings, and
the extension portion spans the multiple openings of the multiple pressure chambers.

5. The liquid discharge head according to claim 3, further comprising:
multiple extension portions including the extension portion,
wherein the common chamber includes multiple common channels,
the multiple nozzles to discharge the liquid in a discharge direction,
the multiple pressure chambers respectively have multiple openings at a first face of the pressure chamber substrate facing the common chamber substrate in the discharge direction,
the first face is opposite to a second face of the pressure chamber substrate facing the nozzle plate in the discharge direction,
the common chamber faces each of the multiple openings, and
the multiple extension portions respectively partition the multiple common channels.

6. The liquid discharge head according to claim 5, further comprising:
a ceiling wall covering the multiple openings in the discharge direction,
wherein the multiple extension portions respectively include multiple ribs:
coupled to the ceiling wall; and
projected from the ceiling wall to the pressure chamber substrate.

7. The liquid discharge head according to claim 5,
wherein the common chamber substrate includes:
a liquid supply portion to supply the liquid to the common chamber; and
a liquid discharge portion to discharge the liquid from the common chamber.

8. The liquid discharge head according to claim 7,
wherein the multiple extension portions span the multiple pressure chambers,
the multiple extension portions partition the multiple common channels,
the multiple common channels include:
a liquid supply portion to supply the liquid to the multiple pressure chambers; and
a liquid discharge portion to discharge the liquid from the multiple pressure chambers.

9. A liquid discharge head comprising:
a nozzle plate having multiple nozzles to discharge a liquid, the multiple nozzles arrayed in a first direction and a second direction intersecting the first direction;
a pressure chamber substrate on the nozzle plate, the pressure chamber substrate having multiple pressure chambers respectively communicating with the multiple nozzles;
multiple actuators, respectively disposed at the multiple nozzles, in the nozzle plate, the multiple actuators to respectively discharge the liquid in the multiple pressure chambers from the multiple nozzles; and
a common chamber substrate on the pressure chamber substrate, the common chamber substrate having a common chamber communicating with each of the multiple pressure chambers; and
multiple heat generators at both sides, in the first direction, of:
the pressure chamber substrate; or
the nozzle plate,
the multiple heat generators arrayed in the second direction; and
an extension portion to transfer a first amount of heat generated from the multiple heat generators in the common chamber in the first direction,
wherein the extension portion transfers a second amount of the heat smaller than the first amount in the common chamber in the second direction.

10. The liquid discharge head according to claim 1,
wherein the common chamber substrate includes silicon.

11. The liquid discharge head according to claim 1,
wherein the heat generator includes a drive circuit to drive the multiple actuators.

12. The liquid discharge head according to claim 11,
wherein the drive circuit drives the multiple actuators.

13. The liquid discharge head according to claim 11,
wherein the drive circuit is:
disposed in the nozzle plate; or
disposed in the pressure chamber substrate.

14. A liquid discharge apparatus comprising:
the liquid discharge head according to claim 1; and
a conveyor to convey a medium to the liquid discharge head, and
the liquid discharge head discharges the liquid onto the medium conveyed by the conveyor.

15. The liquid discharge head according to claim 1, further comprising:
multiple extension portions including the extension portion, each of the multiple extension portions extending from one end to another end of the common chamber in the first direction; and
multiple heat generators including the heat generator, multiple heat generators at both ends, in the first direction, of:
the pressure chamber substrate; or,
the nozzle plate,
wherein multiple extension portions transfer a first amount of heat generated from the multiple heat generators in the common chamber in the first direction, and
the multiple extension portions transfer a second amount of the heat smaller than the first amount in the common chamber in the second direction.

16. The liquid discharge head according to claim 1,
wherein the extension portion includes a continuous wall extending in the first direction.

17. The liquid discharge head according to claim 1,
wherein the extension portion includes an intermittent wall arrayed in the first direction.

18. The liquid discharge head according to claim 1,
wherein common chamber substrate has supply openings, at both ends of the common chamber substrate in the second direction, to supply the liquid to the common chamber.

19. The liquid discharge head according to claim 1, further comprising:
two heat generators including the heat generator,
wherein the two heat generators at both ends of the common chamber substrate in the first direction, and
the multiple nozzles are disposed between the two heat generators in the first direction.

20. The liquid discharge head according to claim 1,
wherein the common chamber substrate includes:
a common supply channel to supply the liquid to the common chamber; and
a common discharge channel to discharge the liquid from the common chamber,
the common supply channel has first interlocking teeth,
the common discharge channel has second interlocking teeth, and
the first interlocking teeth and the second interlocking teeth are interlocked with each other.
